(19) United States
(12) Patent Application Publication
(10) Pub. No.: US 2022/0195167 A1
(43) Pub. Date: Jun. 23, 2022

(54) COMPOSITIONS COMPRISING STYRENATED BLOCK COPOLYMER, NON-POLAR OIL AND POLAR OIL

(71) Applicant: L'OREAL, Paris (FR)

(72) Inventors: Andrea Erin SCHOTT, Summit, NJ (US); Daniella Cristina GONZALEZ-TORO, Hoboken, NJ (US); Hy Si BUI, Piscataway, NJ (US)

(73) Assignee: L'OREAL, PARIS (FR)

(21) Appl. No.: 17/126,625

(22) Filed: Dec. 18, 2020

(51) Int. Cl. C08L 23/22; C08L 23/24

(52) U.S. Cl. CPC C08L 23/22; C08L 2205/03; C08L 23/24

(57) ABSTRACT

The present invention relates to compositions for application to lips. The compositions include at least about 8% by weight of a thermoplastic block copolymer comprising styrenated blocks; at least one non-polar oil and at least one polar oil having a molecular weight of less than 650 g/mol. The ratio of the concentrations by weight of the at least one non-polar oil to the concentration by weight of the at least one polar oil having a molecular weight of less than 650 g/mol is at least about 1:1.

### FIELD OF THE INVENTION

The present invention relates to compositions including thermoplastic block copolymers and, in particular, compositions including thermoplastic block copolymers, non-polar oils and polar oils.

### DISCUSSION OF THE BACKGROUND

Various compositions are known to apply to human lips for cosmetic effect. For example, lip stick and lip gloss compositions, are typically formulated to possess color, shine or gloss characteristics upon application. Lip gloss compositions in particular are sought after to provide high gloss and shine. However, the inventors have noted that conventional lip gloss compositions generally don't provide a perception of volume, which is a desirable consumer attribute. Approaches to build volume include using irritants such as capsaicin and vasodilators such as niacin and nicotinic acid derivatives. Such ingredients do not provide cosmetic lip volume and generally do not always provide the most satisfying solution to the consumer. The inventors have also recognized that conventional products do not simultaneously provide the ability to build a thick layer on the lips, long-lasting durability, and self-leveling films that provide high gloss and hide lip lines.

The inventors have now identified compositions that overcome one or more of the above-mentioned drawbacks.

### SUMMARY OF THE INVENTION

The present invention relates to compositions for application to lips. The compositions include at least about 8% by weight of a thermoplastic block copolymer comprising styrenated blocks. The compositions further comprise at least one non-polar oil and at least one polar oil having a molecular weight of less than 650 g/mol. The at least one non-polar oil and the at least one polar oil that has a molecular weight of less than 650 g/mol are present such that the ratio of the concentrations by weight of the at least one non-polar oil to the concentration by weight of the at least one polar oil having a molecular weight of less than 650 g/mol is at least about 1:1. The compositions have a Zero Shear Viscosity at 32° C. is in a range of 15 Pa·s to 90 Pa·s, a Critical Shear Rate that is from about 10 s⁻¹ to about 250 s⁻¹ at any temperature between 32° C. and 37° C., and a Normal Stress of from about 50 Pa to about 10,000 Pa at any temperature between 32° C. and 37° C.

According to certain embodiments, these compositions have a concentration by weight of the thermoplastic block copolymer comprising styrenated blocks is from about 8% to about 15%, a concentration by weight of the at least one non-polar oil is from about 20% to about 75%, and a concentration by weight of the at least one polar oil having a molecular weight of less than 650 g/mol that is from about 1% to about 50%.

According to certain other embodiments, the concentration by weight of the thermoplastic block copolymer comprising styrenated blocks is from about 8% to about 15%, the concentration by weight of the at least one non-polar oil, such as a polyolefin, is from about 30% to about 65%, the concentration by weight of the at least one polar oil, such as a fatty ester, having a molecular weight of less than 650 g/mol is from about 2% to about 30%, and the ratio of the concentration by weight of the at least one non-polar oil to the concentration by weight of the at least one polar oil having a molecular weight of less than 650 g/mol is from about 1:1 to about 14:1 (such as from about 3:1 to about 14:1); and the composition further comprises from about 5% to about 30% of additional fatty compounds.

According to other aspects, the present invention also relates to methods of enhancing the appearance of lips by applying compositions of the present invention to lips in an amount sufficient to enhance the appearance of lips.

It is to be understood that both the foregoing general description and the following detailed description are exemplary and explanatory only, and are not restrictive of the invention.

### DETAILED DESCRIPTION OF THE INVENTION

As used herein, the expression “at least one” means one or more and thus includes individual components as well as mixtures/combinations.

All concentrations/percentages listed are by weight unless otherwise noted. Numerical ranges are inclusive of endpoints and meant to include all combinations and sub-combinations. For example, from about 5%, 10% or 15% to about 20%, 50% or 60% means about 5% to about 20%, about 5% to about 50%, about 5% to about 60%, about 10% to about 20%, about 10% to about 50%, about 10% to about 60%, about 15% to about 20%, about 15% to about 50%, or about 15% to about 60%.

Other than in the operating examples, or where otherwise indicated, all numbers expressing quantities of ingredients and/or reaction conditions are to be understood as being modified in all instances by the term “about,” meaning within 10% of the indicated number, such as within about 5%, such as within 1% or 2% of the indicated number.

“Actives basis” as used herein means considering only the particular component of ingredient (e.g., in a composition) and ignoring other chemically unrelated components that may be also be present in the same raw material source of that particular component.

“Polymer” as used herein means a compound which is made up of at least two monomers.

“Substantially free” as it is used herein means that while it is preferred that no amount of the specific component be present in the composition, it is possible to have very small amounts of it in the compositions of the invention provided that these amounts do not materially affect at least one, preferably most, of the advantageous properties of the conditioning compositions of the invention. In certain embodiments, substantially free means less than about 2% of the identified ingredient, such as less than about 1%, such as less than about 0.5%, such as less than about 0.1% of the ingredient. In certain embodiments, compositions of the present invention are anhydrous, meaning substantially free of water.

“Substituted” as used herein, means comprising at least one substituent. Non-limiting examples of substituents include atoms, such as oxygen atoms and nitrogen atoms, as well as functional groups, such as hydroxyl groups, ether groups, alkoxy groups, acyloxyalky groups, oxyalkylene groups, polyoxyalkylene groups, carboxylic acid groups, amine groups, acylamino groups, amide groups, halogen containing groups, ester groups, thiol groups, sulphonate groups, thiosulphate groups, siloxane groups, hydroxyalkyl groups, and polysiloxane groups. The substituent(s) may be further substituted.

“Volatile”, as used herein, means having a flash point of less than about 50° C.

The compositions and methods of the present invention can comprise, consist of, or consist essentially of the essential elements and limitations of the invention described herein, as well as any additional or optional ingredients, components, or limitations described herein or otherwise useful in personal care products, especially lip products.

Thermoplastic Block Copolymer Comprising Styrenated Blocks

The block copolymers of the present invention are characterized by the presence of at least one “hard” segment, and at least one “soft” segment. Aside from their compositional nature, the hard and soft segments of the block copolymers of the present invention may be defined in terms of their respective glass transition temperatures, T_{g}. The hard segment may have a T_{g} of 50° C. or more, whereas the soft segment may have a T_{g} of 20° C. or less. The T_{g} for the hard block can range from 50° C. to 150° C. The T_{g} for the soft block can range from can range from −150° C. to 20° C.

Block copolymers useful in compositions of the present invention may be thermoplastic elastomers. The hard segments of the thermoplastic elastomer typically comprise vinyl monomers in varying amounts. Examples of suitable vinyl monomers include, but are not limited to, styrene as well as other optional monomers including methacrylate, acrylate, vinyl ester, vinyl ether, vinyl acetate, and the like.

The soft segments of the thermoplastic elastomer comprise olefin polymers and/or copolymers which may be saturated, unsaturated, or combinations thereof. Suitable olefin copolymers may include, but are not limited to, ethylene/propylene copolymers, ethylene/butylene copolymers, propylene/butylene copolymers, polybutylene, polyisoprene, polymers of hydrogenated butanes and isoprenes, and mixtures thereof.

Thermoplastic elastomers useful in the present invention are block copolymers e.g., di-block, tri-block, multi-block, radial and star block copolymers, and mixtures and blends thereof. A di-block thermoplastic elastomer is usually defined as an A-B type or a hard segment (A) followed by a soft segment (B) in sequence. A tri-block is usually defined as an A-B-A type copolymer or a ratio of one hard, one soft, and one hard segment. Multi-block or radial block or star block thermoplastic elastomers usually contain any combination of hard and soft segments, provided that the elastomers possess both hard and soft characteristics.

In some embodiments, the thermoplastic elastomer of the present invention may be chosen from the class of KRATON rubbers (Kraton Corporation of Houston, Tex.) or from similar thermoplastic elastomers. KRATON rubbers are thermoplastic elastomers in which the polymer chains comprise a di-block, tri-block, multi-block or radial or star block configuration or numerous mixtures thereof. The KRATON tri-block rubbers have polystyrene (hard) segments on each end of a rubber (soft) segment, while the KRATON di-block rubbers have a polystyrene (hard) segment attached to a rubber (soft) segment. The KRATON radial or star configuration may be a four-point or other multipoint star made of rubber with a polystyrene segment attached to each end of a rubber segment. The configuration of each of the KRATON rubbers forms separate polystyrene and rubber domains.

Each molecule of KRATON rubber is said to comprise block segments of styrene monomer units and rubber monomer and/or co-monomer units. The most common structure for the KRATON triblock copolymer is the linear A-B-A block type styrene-butadiene-styrene, styrene-isoprene-styrene, styrene-ethylenepropylene-styrene, or styrene-ethylenebutylene-styrene. The KRATON di-block is preferably the AB block type such as styrene-ethylenepropylene, styrene-ethylenebutylene, styrene-butadiene, or styrene-isoprene. The KRATON rubber configuration is well known in the art and any block copolymer elastomer with a similar configuration is within the practice of the invention. Other block copolymers are sold under the tradename Septon (which represent elastomers known as SEEPS, sold by Kurary, Co., Ltd) and those sold by ExxonMobil Chemical under the tradename VECTOR.

Other thermoplastic elastomers useful in the present invention include those block copolymer elastomers comprising a styrene-butylene/ethylene-styrene copolymer (tri-block), an ethylene/propylene-styrene copolymer (radial or star block) or a mixture or blend of the two. (Some manufacturers refer to block copolymers as hydrogenated block copolymers, e.g. hydrogenated styrene-butylene/ethylene-styrene copolymer (tri-block)).

Compositions of the present invention include at least one block copolymer, e.g, diblock, triblock, multiblock or radial block copolymers, and mixtures thereof. The at least one block copolymer comprises at least one styrene block and may further comprise at least one block comprising units chosen from butadiene, ethylene, propylene, butylene and isoprene or a mixture thereof.

Diblock copolymers that may be mentioned include but are not limited to styrene/ethylene-propylene copolymers (comprising a styrene block and a block obtained from ethylene and propylene), styrene/ethylene-butylene copolymers, styrene-ethylene/butadiene copolymers, styrene/butadiene copolymers and styrene/isoprene copolymers.

In certain notable embodiments, the block copolymer includes styrene blocks and one or more blocks selected from: butadiene blocks, isoprene blocks, and ethylene-butylene blocks. In other embodiments, the block copolymer includes (1) styrene blocks and butadiene blocks; or (2) styrene and ethylene-butadiene blocks; or (3) styrene and isoprene blocks.

Triblock copolymers that may be mentioned include but are not limited to styrene/ethylene-propylene/styrene copolymers, styrene/ethylene-butylene/styrene copolymers, styrene/ethylene-butadiene/styrene copolymers, styrene/isoprene/styrene copolymers and styrene/butadiene/styrene copolymers. For instance, triblock polymers sold under the names KRATON G1650, KRATON G1652, KRATON D1101, KRATON D1102 and KRATON, commercially available from the company Kraton Polymers.

For instance, a mixture of a diblock copolymer and of a triblock copolymer may be used as block copolymer. According to at least one embodiment, the diblock copolymer and the triblock copolymer may be chosen from block copolymers comprising at least one styrene block and at least one block comprising units chosen from butadiene, ethylene, propylene, butylene and isoprene. In one embodiment, the block copolymer has from about 50% to about 90% triblock and from about 10% to about 50% diblock.

Examples of suitable block copolymers include Kraton G series such as Kraton G1701 (INCI name of Hydrogenated Styrene/Isoprene Copolymer) and KRATON G1657 (HYDROGENATED STYRENE/BUTADIENE COPOLYMER). KRATON G1657 (styrene-ethylene/butylene-styrene triblock and 30% styrene-ethylene-butylene diblock); INCI: HYDROGENATED STYRENE/BUTADIENE COPOLYMER; a mixture of 70% styrene-ethylene-butylene triblock) is particularly notable.

It is preferred that the styrene content of the block copolymer be less than 30% by weight, preferably less than 25% by weight, and more preferably less than 20% by weight, and more preferably from about 5% to about 15%, based on the weight of the block copolymer. This is because of the tendency of block copolymers having a styrene content of greater than 30% by weight to harden/gel in conventional carrier systems.

The inventors have found that the thermoplastic block copolymer comprising styrenated blocks may desirably be present in the cosmetic composition in an amount ranging from, for example, about 5%, 6%, 8%, 10% or 12% to about 12%, 14%, 15%, 18%, 20% or 25% by weight. In certain notable embodiments, the thermoplastic block copolymer comprising styrenated blocks is present in a concentration of at least about 8%, such as from about 8% to about 15%, such as from about 10% to about 15%.

In certain embodiments, the thermoplastic block copolymer comprising styrenated blocks may represent from about 10%, 15%, or 20% by weight to about 20%, 40%, 60%, 80%, 90% or 100% by weight of all polymers in the composition.

Compositions of the present invention include non-polar oils and polar oils. As used herein, by “oils,” it is meant compounds suitable for cosmetic use and having a melting point of less than about 30° C. and generally insoluble in water and includes a hydrophobic moiety, such as one meeting one or more of the following three criteria: (a) has a carbon chain of at least six carbons in which none of the six carbons is a carbonyl carbon or has a hydrophilic moiety (defined below) bonded directly to it; (b) has two or more alkyl siloxy groups; or (c) has two or more oxypropylene groups in sequence. The hydrophobic moiety may include linear, cyclic, aromatic, saturated or unsaturated groups. While in certain embodiments, the oil may include fatty acids or fatty alcohols, in certain other embodiments, the oil is in certain embodiments not amphiphilic and, as such, in this embodiment does not include hydrophilic moieties, such as anionic, cationic, zwitterionic, or nonionic groups, that are polar, including sulfate, sulfonate, carboxylate, phosphate, phosphonate, ammonium, including mono-, di-, and trialkylammonium species, pyridinium, imidazolinium, amidinium, poly(ethyleneiminium), ammonioalkylsulfonate, ammonioalkylcarboxylate, amphoacetate, and poly(ethyleneoxy)sulfonyl moieties. In certain embodiments, the oil does not include hydroxyl moieties.

The cosmetic oil is a solvent for the thermoplastic block copolymer and therefore is capable of dissolving at least portions of the thermoplastic block copolymer when mixed in proportions described herein.

Non-Polar Oil

Compositions of the present invention include at least one non-polar oil. Without wishing to be bound by theory, it is believed the non-polar oil functions to solvate the flexible “rubber” mid-blocks of the thermoplastic block copolymer.

By “non-polar oil,” it is meant a hydrocarbon oil. By “hydrocarbon,” it is meant an oil whose molecules contain only hydrogen and carbon (devoid of heteroatoms) and may be linear or branched. In certain embodiments, the non-polar oil has a partition coefficient (log P) value of greater than 15, such as greater than about 20. According to certain other embodiments the non-polar oil is selected from an alkane, an olefin (alkene) such as a polyolefin, and combinations thereof. Suitable alkanes include, for example, C10-C20 alkanes, such as C12-C16 alkanes such as isoheaxadecane or isododecane; or isoparaffins.

According to certain embodiments, the non-polar oil is an olefin such as a polyolefin. Suitable polyolefins include oligomeric or polymeric compounds such as squalene, hydrogenated polyisobutene, hydrogenated polydecene, hydrogenated poly(6-14) olefin, and polybutenes having a molecular weight of less than about 650.

According to certain embodiments, the non-polar oil is present in a concentration by weight from about 15%, 20%, 25%, 30%, 35%, 40% or 45% to about 60%, 65%, 75% or 80% by weight.

Polar Oils

Compositions of the present invention include at least one polar oil. Without wishing to be bound by theory, it is believed the polar oil functions to solvate both the soft “rubber” mid-blocks of the thermoplastic block copolymer as well as the hard styrenated blocks, thereby reducing viscosity.

By “polar oil,” it is meant an oil comprising a polar functional group such as an ester group. Further, the inventors have found that the polar oil should have a molecular weight of less than about 650 g/mol, such as less than about 500 g/mol, such as from about 150 g/mol to about 650 g/mol, such as from about 150 g/mol to about 500 g/mol. Accordingly, another term used for these compounds is in this specification is “mid-molecular weight polar oils.” In certain embodiments, the polar oil has a partition coefficient (log P) value of less than or equal to about 20 such as less than about 17, such as less than about 15. Without wishing to be bound by theory, it is believed that the moderate molecular weights allow better solvation of the styrenated and rubber blocks, enabling reduction of viscosity.

The at least one polar oil may be selected from a fatty ester. Suitable fatty esters include vegetable oils (glyceryl esters of fatty acids, monoglycerides, diglycerides, triglycerides) and synthetic esters.

Specific non-limiting examples of such polar oils include, without limitation, Isodecyl neopentanoate (log P=6.00), Diethylhexyl malate (log P=6.61); Isopropyl myristate (log P=7.43); Isopropyl palmitate (log P=8.49); Tricaprylin (log P=9.33); Isopropyl isostearate (log P=9.37); Isostearyl neopentanoate (log P=10.25); Octyldodecyl neopentanoate (log P=11.32); Ethylhexyl palmitate (log P=11.34); Ethylhexyl stearate (log P=12.40) and Cetyl palmitate (Log P=15.59); Tridecyl trimellitate (log P=16.54); and Diisostearyl malate (log P=16.87).

The polar oil may be present in the composition in a concentration from about 1% 2% 3% 5% or 10% to about 15% 25% 30% or 50% by weight.

The inventors have found that the at least one non-polar oil and the at least one polar oil having a molecular weight of less than 650 g/mol should be present in concentrations by weight such that a ratio of the concentration by weight of the at least one non-polar oil to the concentration by weight of the at least one polar oil having a molecular weight of less than 650 g/mol is at least about 1:1. According to certain embodiments, this ratio is from about 1:1, 2:1. 3:1, 4:1 or 5:1 to about 6:1, 7:1, 8:1, 9:1, 10:1, 11:1, 12:1, 13:1 or 14:1. According to certain notable embodiments, this ratio is from about 1:1 to about 14:1. According to certain other embodiments, this ratio is from about 3:1 to about 14:1.

According to certain other embodiments, the inventors have found that when the concentration by weight of thermoplastic block copolymer comprising styrenated blocks in the composition is high, such as greater than 10%, such as at least about 12%, such as from about 12% to about 15%, it may be desirable to select one, more or all of certain specific design criteria for the composition. For example, in this situation it may be desirable to (a) use a ratio of the concentration by weight of the at least one non-polar oil to the concentration by weight of the at least one polar oil having a molecular weight of less than 650 g/mol is from about 1:1 or 2:1 or 3:1 to about 4:1, 5:1, 6:1, 7:1 or 8:1; (b) select the polar oil having a molecular weight of less than 650 g/mol to have a log P that is relatively low, such as less than about 11, such as from about 5, 6, or 7 to about 8, 9, 10 or 11; and/or (c) select the non-polar oil to have a molecular weight less than about 400 or to include hydrogenated polyisobutene.

Additional Fatty Compounds

According to embodiments, the composition may include additional fatty compounds. Suitable additional fatty compounds include additional polar oils, such as those having molecular weights greater than 650 g/mol (“high molecular weight polar oil”) such any of various vegetable oils and vegetable-derived fatty compounds such as, for example, coconut oil, jojoba oil, grapeseed oil, and certain liquid esters such as Pentaerithrityl Tetraisostearate, and the like.

Other suitable additional fatty compounds include fatty compounds that are not liquid at ambient temperatures and pressures, such as solid fatty compounds including waxes. By solid fatty compounds it is meant lipophilic fatty compounds that are solid at room temperature (about 25° C.) and atmospheric pressure (760 mm Hg, i.e., 105 Pa). By waxes it is meant solid fatty compounds which undergo a reversible solid/liquid change of state and which has a melting point of greater than 30° C., and in some embodiments, greater than about 55° C. up to about 120° C. or even as high as about 200° C.

Examples of waxes include waxes of animal origin, waxes of plant origin, waxes of mineral origin and waxes of synthetic origin. Examples of waxes of animal origin include beeswaxes, lanolin waxes and Chinese insect waxes. Examples of waxes of plant origin include rice waxes, carnauba wax, candelilla wax, ouricurry wax, cork fiber waxes, sugar cane waxes, Japan waxes, sumach wax and cotton wax. Examples of waxes of mineral origin include paraffins, microcrystalline waxes, montan waxes and ozokerites. Examples of waxes of synthetic origin include polyolefin waxes, e.g., polyethylene waxes (linear, low molecular weight polyethylene waxes), waxes obtained by Fischer-Tropsch synthesis, waxy copolymers and their esters, and silicone and fluoro waxes. Other examples of solid fatty compounds include such esters as, for example, Butyrosperum parkii (shea) butter (log P˜21-29) other cosmetic vegetable/nut butters; BIS-diglyceryl Polyacyladipate-2, and the like. In certain embodiments the additional fatty compounds have a molecular weight greater than 650 g/mol, such as from about 800 g/mol to about 2000 g/mol.

According to certain embodiments, the additional fatty compounds include both a high molecular weight polar oil and a solid fatty compound. If present, the amount of additional fatty compounds present in the composition is from about 5%, 10%, 12%, 15% to about 20%, 25%, 30% or 50% by weight. If present, waxes may be present in concentrations of less than about 10%, such as less than about 5%, such as from about 0.1% to about 5%.

Other Cosmetic Ingredients

According to embodiments, the composition may include other cosmetic ingredients such as additional polymers, particulates colorants, fragrances, preservatives and/or silicones. The total concentration by weight of the additional ingredients may range from about 0%, 0.1%, 1%, 2%, 3%, or 4% to about 8%, 10%, 15%, 25%, or 30%, 50%.

Suitable additional polymers include certain polymers that may not qualify as oils and/or certain polymers that do not solvate the soft rubber mid blocks of the thermoplastic block copolymer comprising styrenated blocks. According to certain embodiments the additional polymers include low molecular weight resins, such as low molecular weight hydrocarbon resins. Examples of suitable low molecular weight resins include hydrocarbon-based resins chosen from olefinic polymers, which may be classified, according to the type of monomer they comprise, as indene polymers, pentadiene resins, cyclopentadiene dimer resins and terpenic resins. Other examples of additional polymers include polybutenes having a molecular weight greater than about 650.

The indene polymers may be chosen from polymers derived from the polymerization in major proportion of indene monomer and in minor proportion of monomers chosen from styrene, methylindene and methylstyrene, and mixtures thereof. These polymers may optionally be hydrogenated, and may have a molecular weight ranging from 200 to 1,500 g/mol.

According to at least one embodiment, the indene hydrocarbon-based polymer is a block copolymer obtained from indene and from styrene or a styrene derivative. According to at least one embodiment, the resin is chosen from indene resins, such as the hydrogenated styrene/methylstyrene/indene copolymers sold under the name “Regalite” by the company Eastman Chemical, such as REGALITE R 1100, REGALITE R 1090, REGALITE R-7100, REGALITE R 1010 HYDROCARBON RESIN and REGALITE R 1125 HYDROCARBON RESIN, as well as those sold under the references Escorez 7105 by Exxon Chem., Nevchem 100 and Nevex 100 by Neville Chem., Norsolene S105 by Sartomer, Picco 6100 by Hercules and Resinall by Resinall Corp.

While in certain embodiments, the one or more hydrocarbon resins are present in a total amount of between about 0.5%, 1%, 2% or 3% to about 3%, 5%, or 10%. In certain other notable embodiments, the compositions of the present invention include less than about 10% of such low molecular weight hydrocarbon resins, such as substantially free of such low molecular weight hydrocarbon resins.

In certain other embodiments, the ratio of concentrations by weight in the composition of the thermoplastic block copolymer to the low molecular weight hydrocarbon resin is not less than 2:1, such as not less than 3:1, such as not less than 4:1, such as not less than 5:1.

According to certain embodiments of the present invention, additional ingredients may include at least one colorant (coloring agent). According to this embodiment, the at least one coloring agent is preferably chosen from pigments, dyes, such as liposoluble dyes, nacreous pigments, and pearling agents.

Representative liposoluble dyes which may be used according to the present invention include Sudan Red, DC Red 17, DC Green 6, ß-carotene, soybean oil, Sudan Brown, DC Yellow 11, DC Violet 2, DC Orange 5, annatto, and quinoline yellow.

The nacreous pigments which may be used according to the present invention may be chosen from white nacreous pigments such as mica coated with titanium or with bismuth oxychloride, colored nacreous pigments such as titanium mica with iron oxides, titanium mica with ferric blue or chromium oxide, titanium mica with an organic pigment chosen from those mentioned above, and nacreous pigments based on bismuth oxychloride.

The pigments, which may be used according to the present invention, may be chosen from white, colored, inorganic, organic, polymeric, nonpolymeric, coated and uncoated pigments. Representative examples of mineral pigments include titanium dioxide, optionally surface-treated, zirconium oxide, zinc oxide, cerium oxide, iron oxides, chromium oxides, manganese violet, ultramarine blue, chromium hydrate, and ferric blue. Representative examples of organic pigments include carbon black, pigments of D & C type, and lakes based on cochineal carmine, barium, strontium, calcium, and aluminum. In certain embodiments, the colorant is present in an amount sufficient for an observer to identify the composition as having a “red” color, e.g. red, reddish-brown, pink, or the like.

If present, it is preferred that the amount of coloring agent present in the composition is less than 20%, such as less than 10%, preferably 5% or less by weight of the total weight of the composition. In certain embodiments, the compositions are substantially free of coloring agents.

According to certain embodiments of the invention, compositions may include particulates such as inorganic particulates. “Inorganic particulate” means any finely divided material that is predominantly inorganic (including inorganic particulates having an organic or silicon-based coating), including titanium dioxide, talc, mica, silica, silica silylates, perlite, kaolin, hectorite, as well as bismuth oxychloride, zinc oxide, among others. The inorganic pigment may be coated or uncoated.

If present, the amount of particulate present in the composition is less than 20%, such as less than 10%, preferably 5% or less by weight of the total weight of the composition, including all ranges and subranges therebetween such as, for example, 1% to 10%.

While the “additional fatty compounds” listed above may lend cosmetic benefit to the compositions of the present invention, according to certain embodiments, compositions of the present invention are substantially free of silicone oils or other silicones, which tend not to be compatible with the ingredients used in compositions of the present invention. Silicone oils include, for example, dimethicone, cyclopentasiloxane and volatile silicones such as linear or cyclic silicone oils having a viscosity at room temperature less than or equal to 6 cSt and having from 2 to 7 silicon atoms; these silicones being optionally substituted with alkyl or alkoxy groups of 1 to carbon atoms. Examples include octamethyltetrasiloxane, decamethylcyclopentasiloxane, dodecamethylcyclohexasiloxane, heptamethyloctyltrisiloxane, hexamethyldisiloxane, decamethyltetrasiloxane, dodecamethylpentasiloxane and their mixtures.

According to certain other embodiments, in order to avoid compatibility problems, compositions of the present invention may be substantially free of silicone polymers, silicone gums and resins, such as those that are solid at room temperature and comprising Si—O—Si repeat units and various hydrocarbon or other organic functional groups.

Silicone resins or siloxysilicate resins include those of the general formula [(R)₃SiO]ₓ(SiO_{4/2})_{y} where R is an alkyl group preferably comprising 1 to 8 carbon atoms. One non-limiting example of a siloxysilicate is trimethylsiloxysilicate, which may be represented by the following formula:

[(CH₃)₃SiO]ₓ(SiO_{4/2})_{y}. In the above formulas, x and y preferably range between numbers such as, 10 and 150, 25 and 125, 35 and 100, and 50 to 80, for example.

Silicone gums can, for example, correspond to the formula:

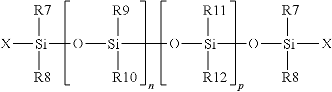

in which:
R₇, R₈, R₁₁ and R₁₂ are identical or different, and each is chosen from alkyl radicals comprising from 1 to 6 carbon atoms,
R₉ and R₁₀ are identical or different, and each is chosen from alkyl radicals comprising from 1 to 6 carbon atoms and aryl radicals,
X is chosen from alkyl radicals comprising from 1 to 6 carbon atoms, a hydroxyl radical and a vinyl radical,
n and p are preferably chosen so as to give the silicone gum a viscosity of from 25,000 cSt to 20,000,000 cSt,

With respect to desirable attributes of the composition, the inventors have found it highly desirable for the compositions to have a particular blend of properties not taught in the prior art. These properties: zero shear viscosity, Shear Thinning Ratio, and High Shear Insult Viscosity are described below.

Zero Shear Viscosity

The inventors have found that in order to build a thick layer of viscous product on the lips that does not drip or flow off the lip, it is desirable that compositions of the present invention have a Zero Shear Viscosity at 32° C. that is at least about 15 Pa·s, such as from about 15 Pa·s to about 90 Pa·s, such as from about 15 Pa·s to about 80 Pa·s, such as from about 15 Pa·s to about 60 Pa·s.

To measure zero shear viscosity (ZSV), approximately 1 gram of a composition is first deposited onto the bottom plate of a rheometer such as a TA Instruments Discovery HR-3 hybrid rheometer equipped with a thermocouple Peltier stage (TA Instruments, New Castle, Del.) set to the desired temperature such as 32° C. A 40 mm flat parallel plate is used as a rheology probe with a gap of 1000 μm between the bottom plate and the probe. Each sample is first equilibrated at 32° C. for 120 seconds, and then a shear rate flow experiment is performed. The duration of experiment is 10 minutes, shear rate changes from 0.001-1000/s, with 5 data points recorded within each decade. After the experiment, a zero-shear viscosity is determined from a log(viscosity) vs. log (shear rate) plot, by linear fitting the initial plateau region to intersect with y-axis. This value represents the viscosity of each formula under unperturbed situation.

Critical Shear Rate

The inventors have found that in order to maintain product on the lips, particularly when performing real-world functions like talking, it is desirable that compositions of the present invention have a Critical Shear Rate that is from about 10 s⁻¹ to about 250 s⁻¹, such as from about 10 s⁻¹ to about 225 s⁻¹, such as from about 10 s⁻¹ to about 100 s⁻¹, at any temperature between 32° C. and 37° C., such as when measured at 32° C. Critical Shear Rate (CTR) is determined using the same experiment as described above for ZSV, e.g., using a rheometer such as a TA Instruments Discovery HR-3 hybrid rheometer equipped with a thermocoupled Peltier stage (TA Instruments, New Castle, Del.) set to 32 C, using a parallel plate geometry with a gap of 1000 um. The sample is loaded onto the stage and allowed to reach equilibrium at 32° C. for 2 min, followed by a 600 s sweep measuring shear viscosity (Pa·s.) and rotational stress (Pa) as a function of applied shear rate. The CSR is found by fitting the SV curve with intersecting linear lines and taking the onset point, or the point of intersection.

Normal Stress

The inventors have found that in order have a wearable thick film that provides a feeling of thickness, it is desirable that compositions of the present invention have a Normal Stress (NS) measured at 800 s⁻¹ that is from about 50 Pa to about 10,000 Pa at any temperature between 25° C. and 37° C., such as when measured at 32° C. According to certain other embodiments, the NS is from about 50 Pa to about 1000 Pa, such as from about 50 Pa to about 500 Pa when measured under such conditions.

To determine NS, the sample is placed in the rheometer as above equilibrated at 32° C. for 120 seconds, using a parallel plate geometry with a gap of 1000 microns. The rotational stress is measured as a function of applied shear rate. The duration of the experiment is 10 minutes, shear rate changes from 0.001-1000/s, with five data points recorded within each decade. If the sample exhibits a normal stress during the measurement, the (Discovery HR-3 hybrid) rheometer will allow the user to record such normal stress. In such cases, the normal stress at 800 s⁻¹ is noted. Positive Normal Stress is indicative that the sample during flow exerts a force that tries to separate the parallel plates of the rheometer. It is more commonly noted with certain samples that include higher molecular weight polymers.

Compositions of the present invention can be applied to the human body. According to certain embodiments, the compositions can be applied to the lips in order to give the appearance of increased lip volume and/or to provide treating, caring or conditioning of the lips. For example, the composition may be spread across the lips of the user. The spreading process generally reduces the composition to a thin layer that adheres to and coats the lips. This may be accomplished with the assistance of a device or applicator. The user may spread the composition across the upper and lower lips covering most or preferably all of the upper and lower lips of the user.

The present invention also relates to methods of enhancing the appearance of lips by applying compositions of the present invention to lips in an amount sufficient to enhance the appearance of lips.

Compositions of the present invention may be made by any of various methods, such as by heating the oil to, for example, about 90° C. and mixing under high shear while slowly adding the thermoplastic styrenated block copolymer. Once the mixture is oil/block copolymer homogeneous, other optional ingredients may be added, such as one at a time.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective measurements. The following examples are intended to illustrate the invention without limiting the scope as a result.

### Example I—Comparative Compositions and Test Results

Four commercial products were tested for ZSV, CSR, and NS at 32° C. The commercial products were the following: M.A.C Lipglass (clear shade) available from Estee Lauder Companies, Dior Lip Maximizer (pink shade) available from Christian Dior SE; Maybelline Lifter Gloss available from L'Oreal S.A, and Lancome L'Absolu Rosy Plump available from L'Oreal S.A, and Buxom Full-On Plumping Lip Polish (clear pearl shade) available from Shiseido Americas. These are shown ass Comp 1, 2, 3, 4, and 5 respectively in Table 1 below. No measurable CSR could be determined for Comp 1 and Comp 5, which both showed near-Newtonian behavior across all measured shear rates. No positive NS was observed in Comp. 1 at a shear rate of 800 s¹.

TABLE 1

| Property | Comp 1 | Comp 2 | Comp 3 | Comp 4 | Comp 5 |
|---|---|---|---|---|---|
| ZSV (Pa · s) | 7.4 | 53.4 | 648 | 265.5 | 9.3 |
| CSR (s⁻¹) | — | 0.03 | 0.01 | 0.03 | — |
| NS (Pa · s) | — | 2.4 | 144.3 | 551.9 | 86.2 |

The results indicate that Comp. 1 had a lower ZSV than desirable and no observed positive NS at 800 s⁻¹; Comp. 2 had a lower CSR than desirable and a lower than desirable NS; Comp. 3 had a higher ZSV and a lower CSR than desirable; Comp. 4 had a had a higher ZSV and a lower CSR than desirable. Comp 5 had a lower ZSV than desirable.

### Example II—Other Compositions and Test Results

Six compositions were prepared and tested for ZSV at 32° C. The compositions are arranged in pairs with each member of a pair having either 10% and a ratio of nonpolar to mid-molecular weight polar oil of 14:1; or 15% of thermoplastic block copolymer (KRATON) and a ratio of nonpolar to mid-molecular weight polar oil of 3:1. The first pair (A1 and A2) included hydrogenated polydecene as non-polar oil (a C10 polyolefin) and isopropyl myristate (low log P, high polarity) as the polar oil having a molecular weight less than about 650 g/mol. The second pair (B1 and B2) included hydrogenated C6-C14 polyolefin as non-polar oil and tridecyl trimellitate (high log P, low polarity) as the polar oil having a molecular weight less than about 650 g/mol. The third pair (C1 and C2) included hydrogenated polyisiobutene as non-polar oil (a C4 polyolefin) and octyldodecyl neopentanoate (moderate log P, moderate polarity) as the polar oil having a molecular weight less than about 650 g/mol.

The concentrations by weight of ingredients are shown in Table 2, below, as are the values for ZSV.

TABLE 2

| INGREDIENT | Ex. A1 | Ex. A2 | Ex. B1 | Ex. B2 | Ex.C1 | Ex. C2 |
|---|---|---|---|---|---|---|
| KRATON G1657 | 10% | 15% | 10% | 15% | 10% | 15% |
| Hydrogenated | 84% | 63.75% | | | | |
| Polydecene | | | | | | |
| (non-polar oil) | | | | | | |
| Hydrogenated | | | 84% | 63.75% | | |
| C6-C14 Olefin | | | | | | |
| (non-polar oil) | | | | | | |
| Hydrogenated | | | | | 84% | 63.75% |
| Polyisobutene | | | | | | |
| (non-polar oil) | | | | | | |
| Isopropyl myristate | 6% | 21.25% | | | | |
| (polar oil) | | | | | | |
| Tridecyl trimellitate | | | 6% | 21.25% | | |
| (polar oil) | | | | | | |
| Octyldodecyl | | | | | 6% | 21.25% |
| neopentanoate | | | | | | |
| (polar oil) | | | | | | |
| ZSV (Pa · s) | 509 | 40 | 2114 | 693 | 8.1 | 33 |

Several things can be observed regarding the data in Table 2. Firstly, when comparing within the pairs, while increasing KRATON independently of other variables generally increases ZSV (this independent effect is not shown here), dropping the ratio of non-polar to mid molecular weight polar oil tends to counter this effect and drop ZSV.

Secondly, Examples C1 and C2 have lower ZSV than corresponding samples of equal amounts of KRATON. This seems to suggest that the lower carbon chain nonpolar oil polyolefin, Hydrogenated polyisobutene induces lower ZSV as compared with higher carbon chain and/or higher molecular weight polyolefins, perhaps from reduced entangling effects with the thermoplastic block copolymer.

Thirdly, Examples B1 and B2 have higher ZSV than corresponding samples of equal amounts of KRATON. This seems to suggest that the high log P (lower polarity than other polar oils tested) polar oil used in these samples does not plasticize the block copolymer as well as other polar oils with lower log P, so it is less able to drop ZSV.

### Example IV— Inventive Compositions, Other Comparative Composition and Test Results

Eight compositions (six inventive, 2 comparative) were prepared and tested for ZSV, SR, and NS at 32° C.

The concentrations by weight of ingredients are shown in Table 2, below, as are the values for ZSV, CSR, and NS.

TABLE 3

| INGREDIENT | INV 1 | INV 2 | INV 3 | INV 4 | INV 5 | INV 6 | CMP 1 | CMP 2 |
|---|---|---|---|---|---|---|---|---|
| KRATON G1657 | 10% | 10% | 15% | 10% | 8% | 10% | 15% | 15% |
| Hydrogenated | | | | 53.2% | 55.3 | | | |
| Polydecene | | | | | | | | |
| (non-polar oil) | | | | | | | | |
| Squalene | | | | | | | | 48.8% |
| Hydrogenated | | | | | | | 39.2% | |
| C6-C14 Olefin | | | | | | | | |
| (non-polar oil) | | | | | | | | |
| Hydrogenated | 53.3% | 52.3% | 39.2 | | | 44.5% | | |
| Polyisobutene | | | | | | | | |
| (non-polar oil) | | | | | | | | |
| Isopropyl myristate | | | 13.1 | 4.0 | | | | 3.5% |
| (polar oil) | | | | | | | | |
| Tridecyl trimellitate | | | | | | 14.8% | 13.1% | |
| (polar oil) | | | | | | | | |
| Octyldodecyl | 4% | 4% | | | 4% | | | |
| neopentanoate | | | | | | | | |
| (polar oil) | | | | | | | | |
| Other Cosmetic | 32.7% | 33.7% | 32.7% | 32.7% | 32.7% | 32.7% | 32.7% | 32.7% |
| Ingredients | | | | | | | | |
| ZSV (Pa · s) | 17.1 | 25.4 | 22.3 | 73.8 | 27.4 | 11.2 | 1427 | 866 |
| CSR (s⁻¹) | 56.8 | 55.8 | 69.3 | 37.0 | 96.6 | 216 | 4.0 | 2.73 |
| NS (Pa) | 300 | 290 | 67.8 | 9807 | 3304 | 360.4 | 28345 | 27620 |

With respect to the “other cosmetic ingredients,” all samples were otherwise identical in that they all included low-molecular weight hydrocarbon resin (5%), inorganic particulate (2%) and preservatives (<1%). All samples also included 25% additional fatty compounds including the specific compounds: Bis-Diglyceryl Polyacyladipate-2, Polybutene (MW of 920), Shea butter; and Pentaerythrityl Tetraisostearate—molecular weights between 800 and 2000). The one exception was that INV 2 had 26% additional fatty compounds and included polyethylene wax. For all samples, the ratio of concentrations by weight in the composition of the thermoplastic block copolymer to the low molecular weight hydrocarbon resin was not less than 2:1.

It can be seen from the above data that CMP1 and CMP 2 had ZSV that was higher than desirable, CSR that was lower than desirable, and NF that was higher than desirable. It can also be generally seen that in order to deliver acceptable CSR and Normal Force, for high levels of Kraton, it is preferable to select one, more or all of the following: lower carbon chain non-polar oils like Hydrogented polyisobutene, lower log P polar oils like isopropyl myristate, and/or lower ratio of non-polar to polar oils.

Inventive Examples INV 1 through INV 6 were evaluated for ability to build a thick layer on the lips, long-lasting durability, and self-leveling films that provide high gloss and hide lip lines. These samples were surprisingly found to perform well on all of these attributes, whereas CMP 1 and CMP 2 lacked the ability to spread across the lips.

What is claimed is:

1. A composition for application to lips, comprising:
at least about 8% by weight of a thermoplastic block copolymer comprising styrenated blocks;
at least one non-polar oil; and
at least one polar oil having a molecular weight of less than 650 g/mol, wherein the at least one non-polar oil and the at least one polar oil are present in concentrations by weight such that a ratio of the concentration by weight of the at least one non-polar oil to the concentration by weight of the at least one polar oil having a molecular weight of less than 650 g/mol is at least about 1:1, wherein the composition has a Zero Shear Viscosity at 32° C. is in a range of 15 Pa·s to 90 Pa·s, wherein the composition has a Critical Shear Rate that is from about 10 s⁻¹ to about 250 s⁻¹ at any temperature between 32° C. and 37° C., and wherein the composition has a Normal Stress of from about 50 Pa to about 10,000 Pa at any temperature between 32° C. and 37° C.

2. The composition of claim 1 wherein the at least one non-polar oil is a polyolefin.

3. The composition of claim 1 wherein the at least one polar oil having a molecular weight of less than 650 g/mol is a fatty ester.

4. The composition of claim 1 comprising from about 8% to about 15% by weight of the thermoplastic block copolymer comprising styrenated blocks.

5. The composition of claim 1 wherein the ratio of the concentration by weight of the at least one non-polar oil to the concentration by weight of the at least one polar oil having a molecular weight of less than 650 g/mol is from about 1:1 to about 14:1.

6. The composition of claim 1 wherein concentration by weight of the thermoplastic block copolymer comprising styrenated blocks is from about 8% to about 15%, wherein the concentration by weight of the at least one non-polar oil is from about 20% to about 75%, and the concentration by weight of the at least one weight polar oil having a molecular weight of less than 650 g/mol is from about 1% to about 50%.

7. The composition of claim 1 wherein a concentration by weight of the thermoplastic block copolymer comprising styrenated blocks is from about 8% to about 15%, wherein the concentration by weight of the at least one non-polar oil is from about 30% to about 65%, and the concentration by weight of the at least one polar oil having a molecular weight of less than 650 g/mol is from about 2% to about 30%. and wherein the composition further comprises from about 5% to about 30% of additional fatty compounds.

8. The composition of claim 1 optionally comprising a low molecular weight hydrocarbon resin, wherein, if present, the concentration by weight of low molecular weight hydrocarbon resin is less than about 10%.

9. The composition of claim 1 further comprising at least one high molecular weight polar oil.

10. The composition of claim 7 further comprising at least one additional fatty compound having a molecular weight greater than 650 g/mol in a concentration by weight from about 5% to about 50%.

11. The composition of claim 1, wherein the thermoplastic block copolymer comprises styrene blocks one or more blocks selected from butadiene blocks, isoprene blocks, and ethylene-butadiene blocks.

12. The composition of claim 1, wherein the thermoplastic block copolymer comprising styrenated blocks is selected from a hydrogenated styrene/butadiene copolymer and a hydrogenated styrene/isoprene copolymer.

13. The composition of claim 1, wherein the composition further comprising from 0.1% to about 25% by weight of one or more other cosmetic ingredients selected from particulates, additional polymers, colorants, preservatives, fragrances and combinations thereof.

14. The composition of claim 1, wherein the composition is anhydrous.

15. The composition of claim 1, wherein if the concentration by weight of thermoplastic block copolymer comprising styrenated blocks is at least 12% by weight in the composition, then one or more of the following conditions are satisfied, (a) the ratio of the concentration by weight of the at least one non-polar oil to the concentration by weight of the at least one polar oil having a molecular weight of less than 650 g/mol is from about 1:1 to about 8:1; (b) the at least one polar oil having a molecular weight of less than 650 g/mol has a log P that is less than about 11, or (c) the at least one non-polar oil to includes hydrogenated polyisobutene.

16. The composition of claim 1 wherein the thermoplastic block copolymer comprising styrenated blocks comprises from about 50% to about 90% by weight of a triblock component and from about 10% to about 50% diblock component.

17. The composition of claim 1 wherein the at least one polar oil having a molecular weight of less than 650 g/mol has a partition coefficient (log P) less than or equal to about 20.

18. A method of enhancing the appearance of lips comprising applying a composition to the lips in an amount sufficient to enhance the appearance of the lips, wherein the composition comprises:
at least about 8% by weight of a thermoplastic block copolymer comprising styrenated blocks;
at least one non-polar oil; and
at least one polar oil having a molecular weight of less than 650 g/mol, wherein the at least one non-polar oil and the at least one polar oil are present in concentrations by weight such that a ratio of the concentration by weight of the at least one non-polar oil to the concentration by weight of the at least one polar oil having a molecular weight of less than 650 g/mol is at least about 1:1, wherein the composition has a Zero Shear Viscosity at 32° C. is in a range of 15 Pa·s to 90 Pa·s, wherein the composition has a Critical Shear Rate that is from about 10 s⁻¹ to about 250 s⁻¹ at any temperature between 32° C. and 37° C., and wherein the composition has a Normal Stress of from about 50 Pa to about 10,000 Pa at any temperature between 32° C. and 37° C.
